(19) United States
(12) Patent Application Publication
(10) Pub. No.: US 2005/0267847 A1
(43) Pub. Date: Dec. 1, 2005

(54) Client-centric e-health system and method with applications to long-term health and community care consumers, insurers, and regulators

(76) Inventor: Elaine A. Blechman, Boulder, CO (US)

Correspondence Address: Eugene Lieberstein, 2151 Long Ridge Road, Stamford, CT, 06903, US

(21) Appl. No.: 10/853,488

(22) Filed: May 25, 2004

Related U.S. Application Data
(63) Continuation-in-part of application No. 10/431,845, filed on May 8, 2003.
Application No. 10/431,845 is a continuation-in-part of application No. 10/210,127, filed on Aug. 1, 2002.

(51) Int. Cl. G06F 17/60

(52) U.S. Cl. 705/75

(57) ABSTRACT

A client-centric Internet information method and system for accessing a client centric relational database via a given website on the Internet with the relational database containing client account database records stored in a multiple of different data categories each representative of a different type of information and records of multiple different functions corresponding to different data operations, comprising the steps of: forming a client user interface for each named client in the database and for each authorized user; assigning a client account ID number for each client account for providing access to a client account and assigning a User ID number for each authorized user; storing authorization records in the relational database defining the categories and functions of operation for each client account; encoding the authorization records for each client account with client specified privileges defining the data categories that can be entered and functions of data operations to be permitted each authorized user, opening a client account in the relational database via selection of the Internet website upon entry of an authorized User ID number and password; and limiting the activity of the authorized user to only the categories and functions of data operations defined by the privileges in the authorization records.

### FIELD OF THE INVENTION

The present invention is a unique client-centric, multi-level, multi-discipline, e-health system (hereinafter “eSystem”) and method. The invention's software system consists of user interfaces, programming logic, a relational database, and client and superset accounts. The invention's unique software method drives the system—programming logic encodes client-specified user privileges and controls users' exercise of their privileges via the user interface on records in the relational database. The invention's unique features related to multi-level, multi-user data access, integration, privacy, permanence, and portability are expressions of the software system and method. The invention has applications to long-term health and community care consumers, healthcare providers and enterprises, health and malpractice insurers, and entities that regulate healthcare accreditation and financing.

### BACKGROUND OF THE INVENTION

Long-term healthcare consumers. Each person is a long-term healthcare consumer, receiving healthcare services from a changing array of providers and enterprises across the lifespan. The highest-volume consumers of long-term healthcare are the elderly and people with chronic illnesses and disabilities—such as Alzheimer's, asthma, autism, cystic fibrosis, cognitive and developmental disabilities, diabetes, multiple sclerosis, schizophrenia, and spinal cord injury. Regardless of physical or mental status, every consumer is entitled to long-term healthcare in the least restrictive environment with an optimal quality of life for them and the least burden for their family caregivers. Long-term healthcare consumers deal with vast, uncoordinated, ever-changing arrays of providers (e.g., ambulance drivers, dieticians, home healthcare assistants, medical technicians, nurses, pharmacists, physical therapists, physicians, psychologists, religious leaders, social workers) and enterprises (e.g., clinical research organizations, hospitals, hospices, insurance companies, Medicare/Medicaid authorities, mental health centers, nonprofit and religious organizations, pharmaceutical companies, state and federal regulatory agencies). Few long-term healthcare clients or family caregivers have explicit knowledge of all the providers and enterprises that see their records, decide about authorization of expensive procedures, establish and follow through on treatment plans. No existing technology offers a cost-effective means of facilitating client-centric teamwork among geographically remote and organizationally independent providers and enterprises. Not surprisingly, a large body of evidence documents inadequacies in service delivery to long-term healthcare consumers including fatal mistakes.

Community-care consumers. Many people (including long-term healthcare consumers) receive services intended to prolong community residence and prevent congregate care in a hospital, nursing home, or prison. The highest volume consumers of community care (aside from the previously described long-term healthcare consumers) are youths at risk for violence or suicide; juvenile and adult criminal offenders; and substance abusers. These consumers and their family caregivers require community-based services that effectively balance individual rights and public safety. Congregate care outside the community in alternative schools, residential treatment facilities, psychiatric hospitals, boot camps, and prisons multiplies costs to taxpayers, while diminishing individual rights and endangering the public. Community-care consumers constantly deal with vast, uncoordinated, ever-changing arrays of providers. Community-care providers include district attorneys, judges, lawyers, nurses, pharmacists, parole and probation officers, physicians, police officers, religious leaders, school psychologists, school principals, social workers, teachers, therapists. Community-care consumers also deal with vast, uncoordinated, ever-changing sets of enterprises. Community-care enterprises include child protective service agencies, clinical research organizations, halfway houses, homeless shelters, hospitals, hospices, insurance companies, Medicare/Medicaid authorities, mental health centers, nonprofit and religious organizations, pharmaceutical companies, prisons, school systems, sex offender registry, state and federal regulatory agencies, substance abuse testing and treatment centers. Few community-care clients or family caregivers have explicit knowledge of all the providers and enterprises that see their records, decide about foster care placement, choose between in-school suspension and alternative schooling, advise judges, decide about authorization of medical procedures, establish and follow through on treatment and court orders. No existing technology offers a cost-effective means of facilitating client-centric teamwork among geographically remote and organizationally independent providers and enterprises. Not surprisingly, a large body of evidence documents inadequate delivery of community-care to at-risk youths who later commit school shootings and parent murders, and to at-risk adults who later commit child neglect, abuse, and murder.

Common dilemmas in long-term healthcare and community care. Common dilemmas in long-term health care and community care include fragmented service delivery, medical mistakes and malpractice, poor outcomes related to morbidity, mortality, rehospitalization, repeat institutionalization, recidivism, client abuse and neglect, inadequate consumer and family involvement, and fraudulent billing.

### UNIQUE NATURE OF PRESENT INVENTION

The present invention is a unique client-centric, multi-level, multi-discipline, e-health system (hereinafter “eSystem”) and method. The invention's software system consists of user interfaces, programming logic, a relational database, and client and superset accounts. The invention's unique software method drives the system—programming logic encodes client-specified user privileges and controls users' exercise of their privileges via the user interface on records in the relational database. The invention's unique features related to multi-level, multi-user data access, data integration, data permanence, data privacy, and data portability are expressions of the software system and method. The invention's system, methods, and features permit unique applications to long-term health and community care consumers, healthcare providers and enterprises, health and malpractice insurers, and entities that regulate healthcare accreditation and financing. Due to its system, method, features, and applications, the invention has unique advantages compared to conventional enterprise-centric electronic information systems.

Definitions of terms. Definitions of key terms in this document are listed below.

Client account. Each consumer has a client account in the eSystem relational database. “Either the consumer (the named client on the account) or the consumer's legal agent (also called “account administrator,”) (e.g., parent, legal guardian, client-designated family caregiver), authorizes user access to the account and defines each user's access privileges to selected data categories and data functions in the client account. “Authorized client account users consistent with their privileges may access a variety of data categories (e.g., criminal, educational, health insurance, legal, medical, mental health, occupational, substance abuse) and then perform a variety of data functions (e.g., view, search, update, edit, save, retire, aggregate, and restore).

Client-account user interface. When an authorized user on an eSystem client account logs on to the eSystem with a valid logon ID and password, the eSystem displays user interface or Web pages consistent with the user's access privileges and preferences. The user interface page includes buttons, data-entry fields, and other devices that allow the user to exercise authorized privileges within the account. These privileges permit users to view, search, update, edit, save, retire, aggregate, and restore information. For example, FIG. 3 displays a series of buttons at the left from “My Home” at the top left to “Emergency Procedures” at the bottom left. Each button corresponds to a data category. The user who accessed this page has privileges related to each of these data categories. Users with lesser privileges would see fewer buttons on the left of this interface page. FIG. 3 displays an “Add New Record” button below the schedule. This button corresponds to a data function, adding an event to the schedule. The user who accessed this page has privileges related to this function. Users with lesser privileges might be able to view the schedule page but would not have access to the “Add New Record” button.

Client-centric system. In a client-centric system, consumers regulate access to their personal information in their client accounts.

Consumer. The consumer is an individual who is a recipient of long-term healthcare or community care services or that individual's family caregiver.

Data categories. Each consumer of long-term healthcare or community care services is associated with a body of information about the consumer's need for services, the nature of services, the cost of services, the process, and outcome of services. This body of information grows over time. This body of information can be broken down into criminal, educational, health insurance, legal, medical, mental health, occupational, substance abuse, and other data categories (or types of information). The eSystem user interface is organized around these data categories. In the user interface page displayed in FIG. 3, there is a button at the left for multiple data categories from “My Home” at the top to “Emergency Procedures” at the bottom. The user clicks on a data category button to open related pages in the user interface. To open the schedule page displayed in FIG. 3, the user has clicked on the “Schedule” button. Only a user with authorized access to the schedule data category sees the schedule button on the left.

Data functions. Each consumer of long-term healthcare or community care services is the associated with a body of information about the consumer's need for services, the nature of services, the cost of services, the process, and outcome of services. This body of information grows over time. This body of information can be broken down into auditing, health insurance transactions, prescription writing, report generation, tracking, scheduling, and other data functions (or operations on information). In the eSystem user interface, data functions are organized within data categories. In the user interface page displayed in FIG. 3, there is an “Add New Record” below the schedule. The user clicks on this button to add an event to the schedule. Only a user with schedule update privileges sees the “Add New Record” button.

Enterprise. An enterprise is an organization such as a clinic, clinical research organization, emergency room, health-maintenance organization, hospital, juvenile court, nursing home, prison, or school system. The enterprise coordinates the efforts of multiple practitioners who provide counseling, detention, educational, emergency response, healthcare, insurance transactions, judicial, law enforcement, medical, mental health, supervision, training, or other services to multiple consumers.

Enterprise account. An enterprise account has all the features of a provider account, plus additional feautures that allow an enterprise organization to manage account authorization within its own organization. Each enterprise account has a designated Security and Privacy Officer (SPO), who is responsible for ensuring that all users within the enterprise organization are properly authorized. If a client account legal agent chooses, they can make an agreement with an enterprise SPO that allows the SPO to authorize enterprise users on the client account.

Enterprise-centric system. In an enterprise-centric system, the enterprise regulates access to consumers' personal information.

Handshake. A handshake is a mechanism by which a client account legal agent and an enterprise account Security and Privacy Officer can agree to share authorization power over a client account. One party offers the handshake to the other. Both parties must agree for authorization sharing to take place. The client account legal agent always retains the ability to sever the agreement.

Multi-discipline. The eSystem has a multi-discipline user interface. When authorized users from different disciplines (e.g., medicine, mental health) logon to the eSystem and enter a client account, they each have selective access to data categories (e.g., medicine, mental health) and data functions (e.g., prescription writing, psychological assessments) consistent with their disciplines.

Multi-level. The eSystem has a multi-level user interface. When authorized users from different levels (e.g., consumer, provider, enterprise representative) logon to the eSystem, each sees a personalized user home page with a selective list of accessible accounts (e.g., consumer's own client account; a client account for each of the provider's patients; a provider account for each enterprise provider). For example, FIG. 4 shows a user home page for a fictional provider, Judy Burge. A “Current Clients” drop-down menu at the center of the page allows Judy to select a client, perhaps Bonnie, and then open Bonnie's client account by clicking the “See Client” button at the right. Provider and enterprise accounts represent superset accounts. The user can click on an accessible account in the list and depending upon access privileges assigned by the client account's legal agent, the user can drill down to specific data categories (e.g., medicine, mental health) and use specific data functions (e.g., prescription writing, psychological assessments, data export, report generation) in one client account. A superset account user can also employ one data function (e.g., report generation) and aggregate across subordinate accounts (e.g., to compile a record of providers' writing of prescriptions for narcotics broken down by clients' gender, ethnicity, age, and health insurance carrier.

Network. A network may be a health or malpractice insurance carrier, a state or federal regulatory agency, a private or public grant-making entity. A network connects multiple enterprises, each coordinating multiple practitioners who provide services to multiple consumers.

Provider. A provider is a practitioner in fields such as education, healthcare, law enforcement, medicine, nursing, psychology, or social work, who offers services to multiple consumers.

Provider account. A provider account allows one or more service providers to aggregate certain functions over multiple client accounts. For example, a provider can run a report on several client accounts from the provider account, rather than running individual reports from each client account.

Relational database. The eSystem relational database includes data tables for each data category and data function. Other tables define matters such as users' authorization privileges and relationships between accounts. An eSystem client account (for Client #1000) includes the rows in each data category and table related to Client 1000. An eSystem superset account (Provider 2545) references the rows in each data category and table related to all subordinate accounts (Provider 2545's authorized client accounts).

Security and Privacy Officer. Enterprise accounts have a Security and Privacy Officer (SPO) who is responsible for the creation, assignment and authorization of accounts within the Enterprise's organization. The system keeps track of which accounts belong to the enterprise account and allows the SPO to exercise authorization power over those accounts. A client account legal agent may choose to allow an enterprise SPO to share authorization power over a client account. This simplifies the authorization process for the client account legal agent and gives the enterprise SPO better control of account access for its workforce.

Superset account. Providers, enterprises, and networks have superset accounts in the eSystem relational database. The named client or legal agent on associated client accounts defines access privileges on superset accounts. Consistent with their privileges, authorized superset account users may selectively access one or more associated client accounts. They may open one or more data categories within selected client accounts (e.g., criminal, educational, health insurance, legal, medical, mental health, occupational, substance abuse). Finally, they may perform a variety of data functions within or across selected data categories (e.g., view, search, update, edit, save, retire, aggregate, restore). In one scenario, access privileges allow a provider's business associates to view and update identified data in the client account (e.g., the social worker's clinical supervisor). In a second scenario, access privileges allow an enterprise's employee (e.g., insurance company medical director) to view and update specified data in the client account (e.g., health insurance transactions related to an August 2002 auto accident). In a third scenario, access privileges allow a network representative (e.g., director of a state child welfare agency) to receive alerts triggered when network enterprises (e.g., social service agencies) and network providers (e.g., case workers) fail to adhere to procedural guidelines (e.g., submit weekly reports on home visits to abused children returned to the home of a previously abusive parent). In general, a superset account user can employ one data function (e.g., search) and aggregate across associated accounts (e.g., to identify doctors broken down by percent compliance with professional practice guidelines for prescription of narcotics to minors).

Superset account user interface. When an authorized user on an eSystem superset account logs on to the eSystem with a valid logon ID and password, the eSystem displays user interface or Web pages consistent with the user's access privileges and preferences. These privileges permit users to view, search, update, edit, save, retire, aggregate, and restore information. For example, FIG. 4 shows a user home page for a fictional provider, Judy Burge who is authorized on multiple client accounts. A “Current Clients” drop-down menu at the center of the page allows Judy to select a client, perhaps Bonnie, and then open Bonnie's client account by clicking the “See Client” button at the right. What Judy can do once she enters Bonnie's account depends upon the data category and data function privileges that Bonnie defined for her.

Objectives. The present eSystem is designed to resolve common dilemmas in the field of long-term healthcare and community care that plague consumers, healthcare providers and enterprises, health and malpractice insurers, and entities that regulate healthcare accreditation and financing. While resolving these dilemmas, the eSystem is designed to surpass the performance of conventional enterprise-centric systems.

Shortcomings of the conventional approach. The conventional approach involves enterprise-centric systems. Enterprise-centric software platforms designed to further the business objectives of private industry have been repackaged and marketed to long-term healthcare and community care providers and enterprises. Enterprise-centric software has evolved to help companies become more profitable than their competitors. Enterprise-centric software is fundamentally incapable of resolving the common dilemmas that cripple the cost-effective delivery of long-term healthcare and community care. In fact, enterprise-centric software perpetuates these common dilemmas. The consumers of long-term healthcare and of community-care deal with vast, uncoordinated, ever-changing array of providers and enterprises that rely on diverse enterprise-centric software. With conventional technology, all the computer-literate providers and enterprises related to one client are using different, unrelated, uncommunicative enterprise-centric systems. Clients' records once resided in many different provider and enterprise filing cabinets, now they reside in many different filing cabinets and on many different provider and enterprise servers. With conventional technology, no one can quickly access all of a client's records in one place, search all these records, or relate one record to one event in the client's history and treatment plans. This is only one example of the insufficiency of conventional technology.

### BRIEF DESCRIPTION OF THE DRAWINGS

Other features and advantages of the present invention will become apparent from the following detailed description of the preferred embodiment when read in conjunction with the following drawings of which:

FIG. 1 is a diagrammatic illustration of the system and method of the present invention with respect to one client account;

FIG. 2 is a diagrammatic illustration of the system and method of the present invention with respect to multiple client accounts;

FIG. 3 is a user interface page of one client account as shown on a video monitor;

FIG. 4 is a user interface page for a superset user account as shown on a video monitor;

FIG. 5(a) illustrates conventional enterprise-centric data integration;

FIG. 5(b) illustrates the client-centric multi-level, multi-discipline user integration feature of the present invention;

FIG. 6(a) illustrates how the enterprise centric consumer privacy in a conventional system operates;

FIG. 6(b) illustrates the client-centric consumer privacy feature of the present invention;

FIG. 7(a) illustrates how a conventional enterprise-centric system works for data category integration;

FIG. 7(b) illustrates the client-centric data category integration feature of the present invention;

FIG. 8(a) illustrates how a conventional enterprise-centric system works for time-dependent data integration;

FIG. 8(b) illustrates the client-centric time dependent integration feature of the present invention;

FIG. 9 illustrates the escalating alert feature of the present invention;

FIG. 10 illustrates the document retrieval feature of the present invention;

FIG. 11 illustrates the data permanence feature of the present invention;

FIG. 12 is a schematic diagram of the infrastructure architecture of the system of the present invention;

FIG. 13(a) illustrates how a conventional enterprise centric system performs health insurance transactions;

FIG. 13(b) illustrates the client-centric health insurance transaction feature of the present invention;

FIG. 14 is a diagrammatic illustration of how authorization sharing of a client account is established between a client account legal agent and an enterprise SPO in accordance with the present invention;

FIG. 15 diagrammatically illustrates how authorization sharing over a client account is limited between a client account legal agent and an enterprise SPO in accordance with the present invention; and

FIG. 16 illustrates how the authorization sharing over a client account is between a client account legal agent and an enterprise SPO is terminated in accordance with the present invention.

### SUMMARY OF THE INVENTION

The present invention is a client-centric e-health system and method with applications to long-term health and community care consumers, insurers, and regulators (hereinafter “eSystem”). The invention is designed to resolve common dilemmas in long-term healthcare and community care. The invention is also designed to overcome shortcomings of the conventional technological approach to long-term healthcare and community care. To achieve these goals, the invention's unique software engine consists of programming logic that applies business rules to operate the eSystem. For example, the eSystem has business rules that restrict a user's client account access to data categories authorized by the account's legal agent or an authorized enterprise Security and Privacy Officer. When a user logs on and enters an account, the client account user interface displays only data categories for which the user has authorized access. The software engine drives the dynamic flow of information back and forth between client account and superset account user interfaces, the relational database, and client and superset accounts that reference relevant database tables. The software engine allows any number of authorized users to simultaneously access any number of data categories and data functions in client and superset accounts.

### DESCRIPTION OF THE PREFERRED EMBODIMENT

The preferred embodiment of the invention's unique system, methods, and features will become apparent from the detailed descriptions of the following drawings:

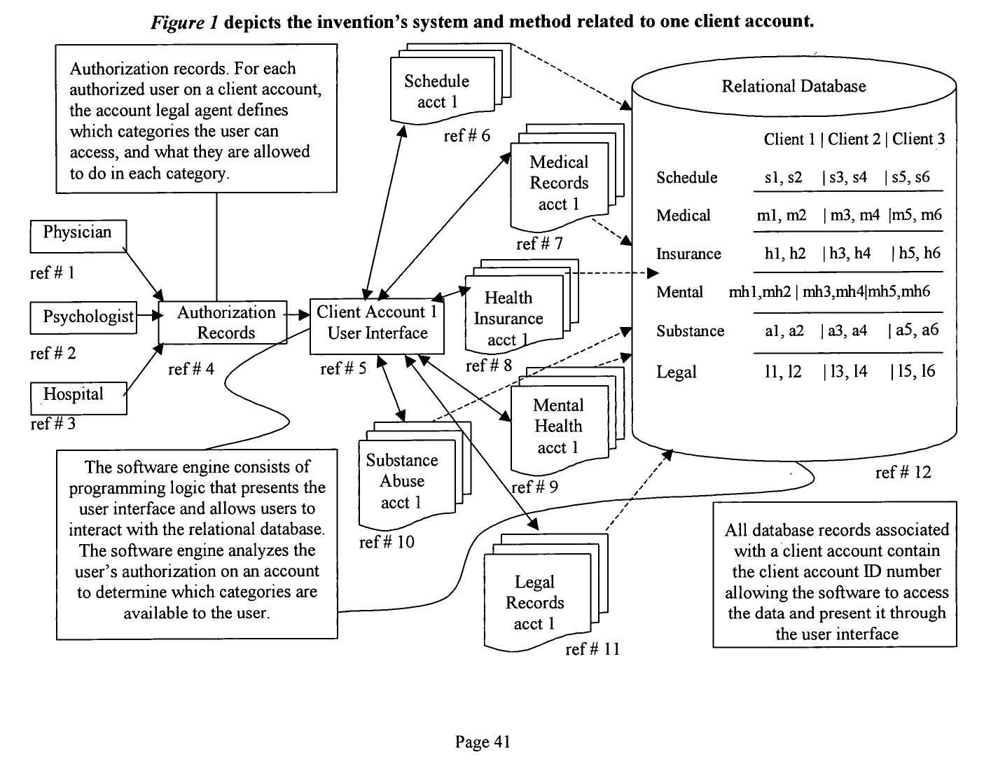

FIG. 1 Depicts the Invention's System and Method in Respect to One Client Account.

The invention's system consists of a client account user interface (ref# 5), a relational database (ref# 12), and a client account composed of multiple data category records (ref# 6-11). The invention's method uses programming logic to encode client-specified user privileges into authorization records (ref# 4). This logic controls users' (ref# 1-3) exercise of their privileges in the client account via the user interface (ref# 5) on records (ref# 6-11) in the relational database (ref# 12).

For purposes of this example, client account 1 relates to a morbidly obese patient with chronic low-back pain (treated by a neurologist, ref# 1), an eating disorder (treated by a psychologist, ref# 2), and a history of two triple bypass operations (performed by a cardiologist, ref# 3). The three authorized users (ref# 1-3) on client account 1 each logon at 4:30 p.m. on August 5^{th} but from different geographical locations. They do this by entering the system's website address into any device equipped with an Internet browser. Once on the Website, each user enters a logon ID and password in user interface fields requesting this information. The programming logic searches authorization records (ref# 4) in the relational database (ref #12) to determine each user's access privileges and opens a client account user interface (ref #5) that supports client-defined access privileges to data categories and data functions within categories. In this figure, the three authorized users have all privileges (including view, edit, update, retire, restore) on all data categories in the client account (ref #6-11). Each user exercises these privileges via devices in the user interface (ref# 5) such as buttons that when clicked, open data category pages or perform data functions.

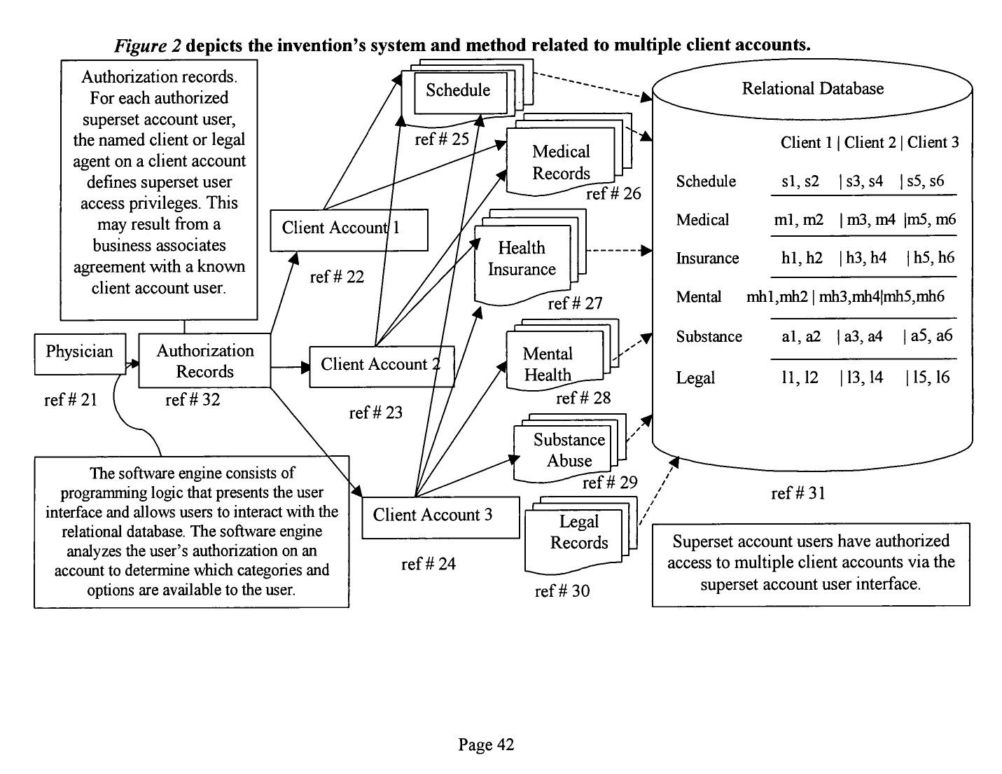

FIG. 2 Depicts the Invention's System and Method in Respect to Multiple Client Accounts.

FIG. 1 depicted the invention's system in relationship to one client account. FIG. 2 depicts a scenario in which a physician is authorized on multiple client accounts through a superset account user interface (ref# 21) consistent with authorization records (ref# 32) that specify the superset user's specific client-authorized access privileges on multiple client accounts (ref# 22-24) each comprising multiple data category records (ref# 25-30) residing in a relational database (ref# 31). The invention's method uses programming logic to encode client-specified user privileges into authorization records (ref# 32) and to control the user's (ref# 21) exercise of access privileges across multiple client accounts (ref# 22-24) each with records (ref# 25-30) in the relational database (ref# 31).

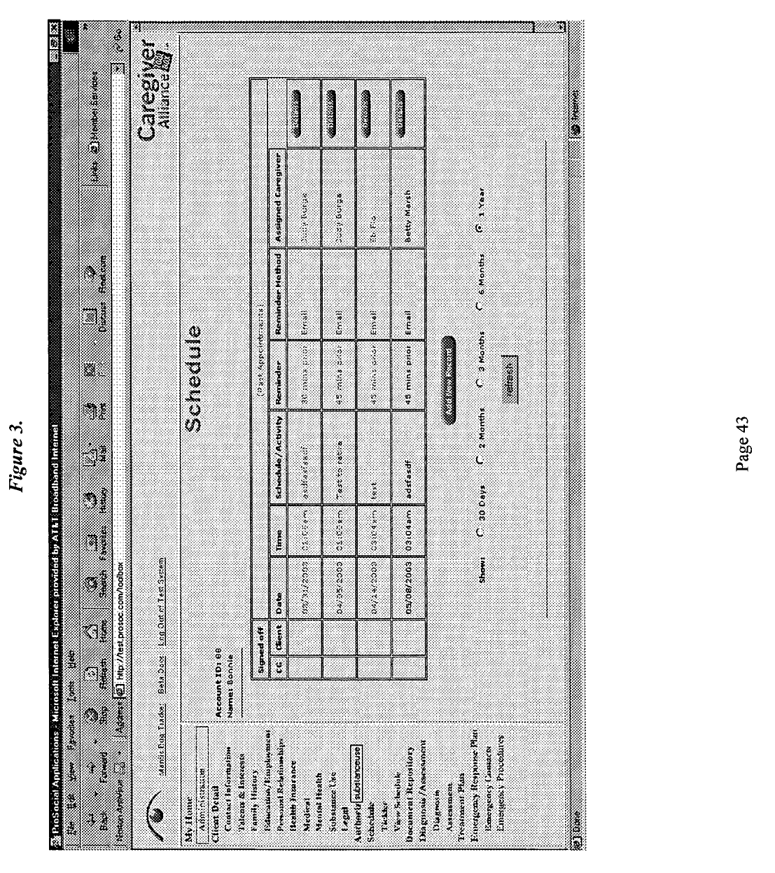

FIG. 3 is a Screen Shot of One Client Account User Interface Page.

When an authorized user on an eSystem client account logs on to the eSystem with a valid logon ID and password, the eSystem displays user interface or Web pages consistent with the user's access privileges and preferences. The user interface page includes buttons, data-entry fields, and other devices that allow the user to exercise authorized privileges within the account. These privileges permit users to view, search, update, edit, save, retire, aggregate, and restore information. For example, FIG. 3 displays a series of buttons at the left from “My Home” at the top left to “Emergency Procedures” at the bottom left. Each button corresponds to a data category. The user who accessed this page has privileges related to each of these data categories. Users with lesser privileges would see fewer buttons on the left of this interface page. FIG. 3 displays an “Add New Record” button below the schedule. This button corresponds to a data function, adding an event to the schedule. The user who accessed this page has privileges related to this function. Users with lesser privileges might be able to view the schedule page but would not have access to the “Add New Record” button.

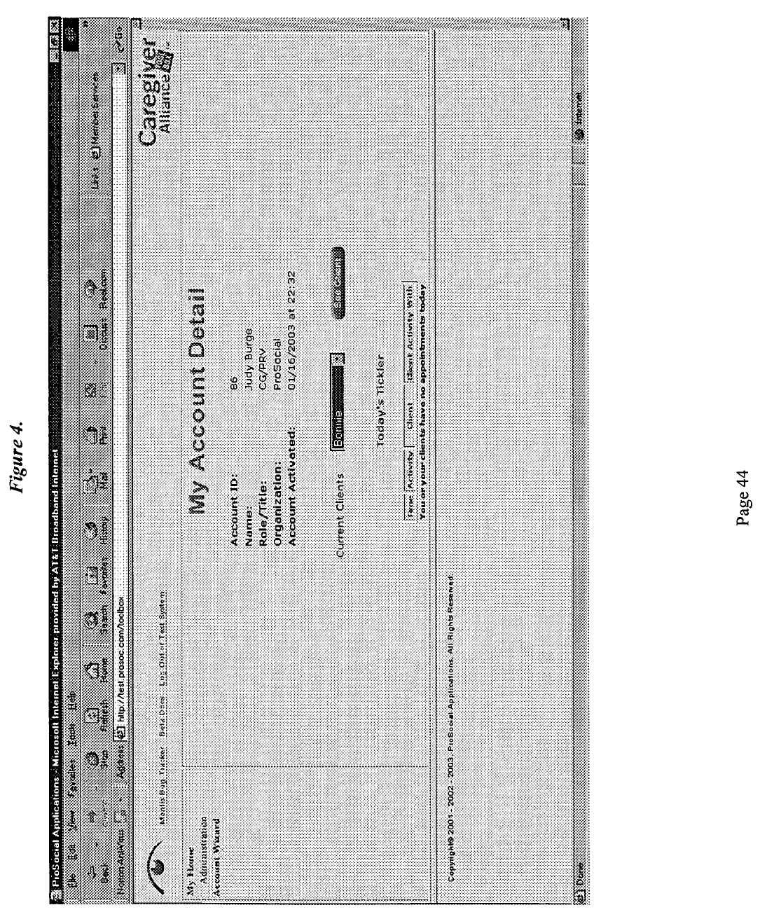

FIG. 4 is a Screen Shot of One Superset Account User Interface Page.

When an authorized user on an eSystem superset account logs on to the eSystem with a valid logon ID and password, the eSystem displays user interface or Web pages consistent with the user's access privileges and preferences. These privileges permit users to view, search, update, edit, save, retire, aggregate, and restore information. For example, FIG. 4 shows a user home page for a fictional provider, Judy Burge who is authorized on multiple client accounts. A “Current Clients” drop-down menu at the center of the page allows Judy to select a client, perhaps Bonnie, and then open Bonnie's client account by clicking the “See Client” button at the right. What Judy can do once she enters Bonnie's account depends upon the data category and data function privileges that Bonnie defined for her.

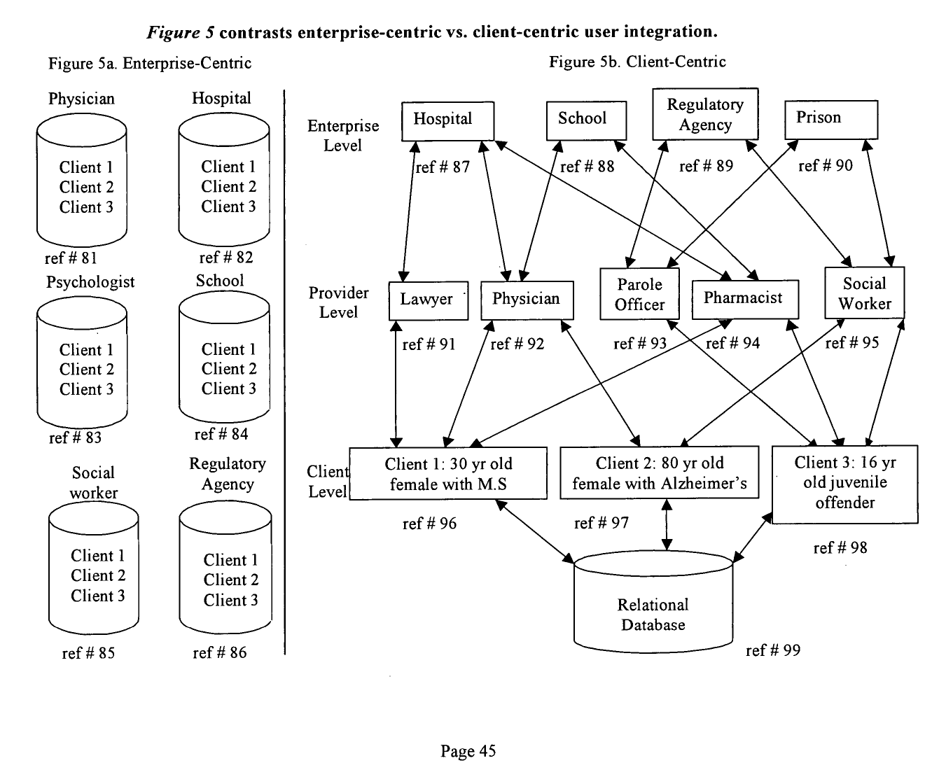

FIG. 5 Contrasts Enterprise-Centric (FIG. 5a) vs. Client-Centric (FIG. 5b) User Integration.

FIG. 5a illustrates conventional enterprise-centric data integration. Three providers (ref #81, 83, 85) and three enterprises (ref #82, 84, 86) each have their own enterprise-centric database (ref #81-86). The lack of connection between enterprise-centric databases (ref #81-86) precludes information sharing or coordination among providers and enterprises providing overlapping services to Clients 1, 2, and 3.

FIG. 5b illustrates the invention's unique client-centric multi-level, multi-discipline user integration feature, an expression of the invention's unique system and methods. FIG. 5b shows user integration across user levels (client, provider, enterprise) and across user disciplines (medicine, psychology, education, social work, regulatory compliance). FIG. 5b shows integrated information sharing and activity coordination among five providers (ref# 91-95) and four enterprises (ref# 87-90) providing overlapping services to three clients (ref# 96-98). One relational database (ref# 99), stores information in each client account so that it is accessible to a multi-level (provider, enterprise), multi-disciplinary (lawyer, physician), ever-changing array of authorized account users.

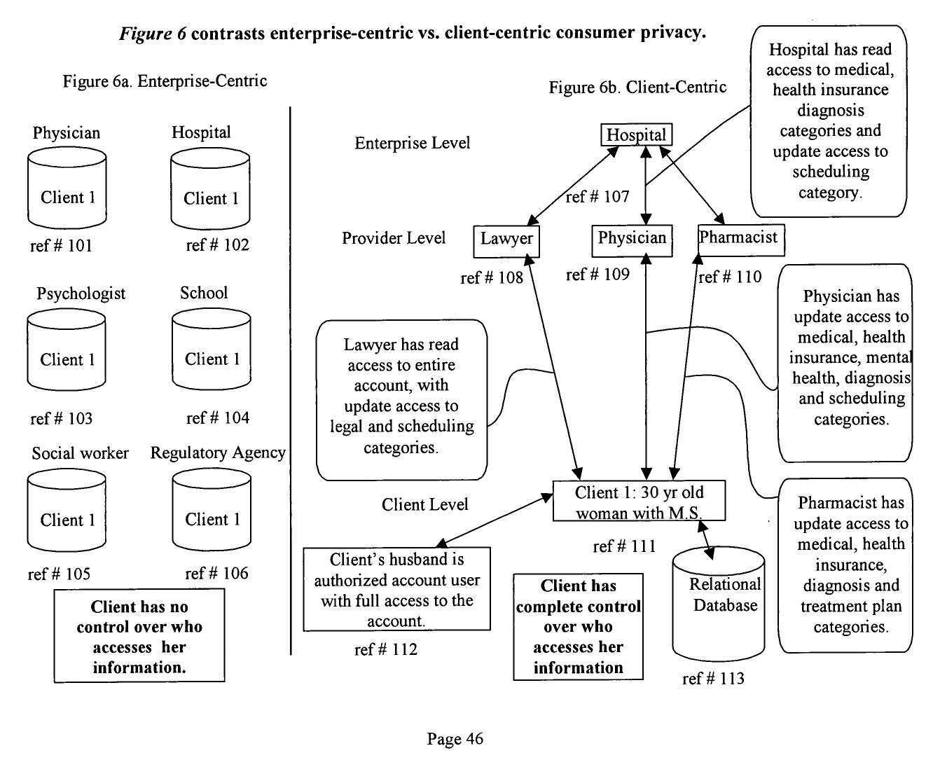

FIG. 6 contrasts enterprise-centric (FIG. 6a) vs. client-centric (FIG. 6b) consumer privacy. In this example, Client 1 is a 30-year-old woman with multiple sclerosis cared for by her husband.

FIG. 6a shows conventional enterprise-centric consumer privacy involving six independent enterprise-centric databases (ref# 101-106), each of which includes fragments of Client 1 healthcare information. The consumer (and her husband) do not know what personal information is in these databases. They exercise no control over users who access personal information in these databases. They do not know and cannot control users who view, update, or delete information in her records in any of these databases.

FIG. 6b illustrates the invention's unique client-centric consumer privacy feature, an expression of the invention's unique system and methods. FIG. 6b shows one client-centric relational database (ref# 113). In the database is Client 1's client account (ref# 111) composed of all data categories of Client 1's healthcare information. Authorized enterprise (ref# 107), provider (ref# 108-110), and family caregiver (ref# 112) users differ in their access privileges to the client account. The client has complete control over user access to her client account. She decides who is an authorized user, what data categories they see in the user interface, what data functions they employ within a data category. She can change these designations at any time through administration functions in the client user interface.

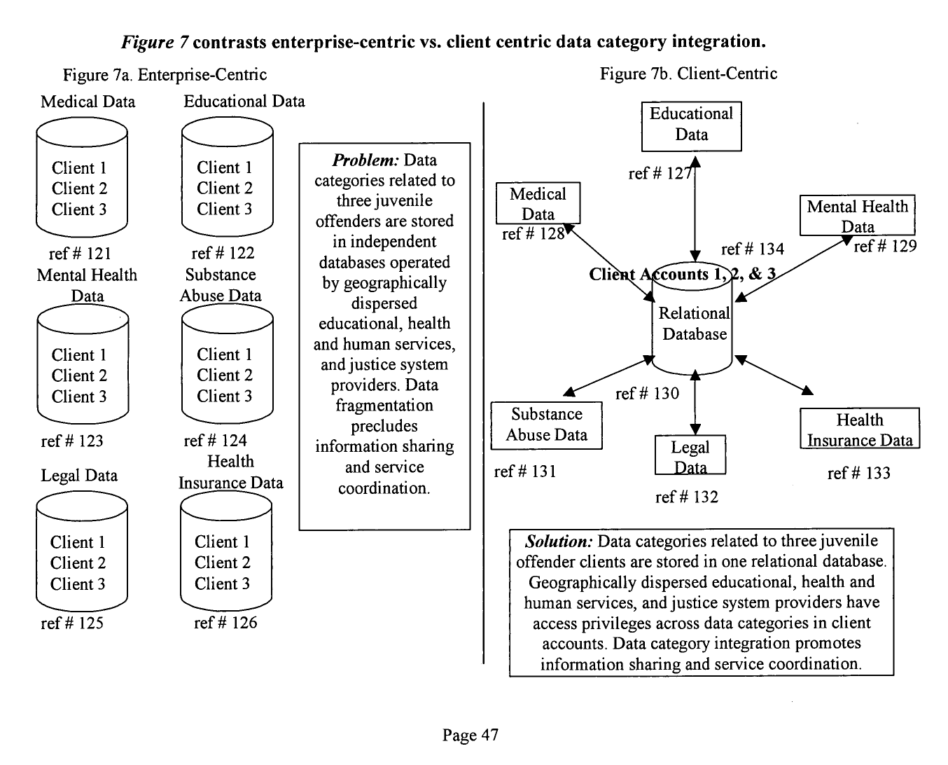

FIG. 7 contrasts enterprise-centric vs. client-centric data category integration. In this example, Clients 1, 2, and 3 are juvenile offenders on probation in the community. Each client receives services from geographically dispersed educational, health and human services, and justice system providers.

FIG. 7a shows conventional enterprise-centric data category integration involving six independent enterprise-centric databases (ref# 121-126). Each database is dedicated to a particular data category (e.g., legal data, medical data) and maintained by a provider (e.g., probation officer, doctor). Fragmented databases prevent geographically dispersed and organizationally unrelated providers from sharing information and coordinating service delivery.

FIG. 7b illustrates the invention's unique client-centric data category integration feature, an expression of the invention's unique system and methods. FIG. 7b shows one client-centric relational database (ref# 130) including three client accounts (ref# 134). Each client account comprises six data categories (ref# 127-132) to which all authorized users have access. Data category integration promotes sharing of information and coordination of service delivery among geographically dispersed and organizationally unrelated providers.

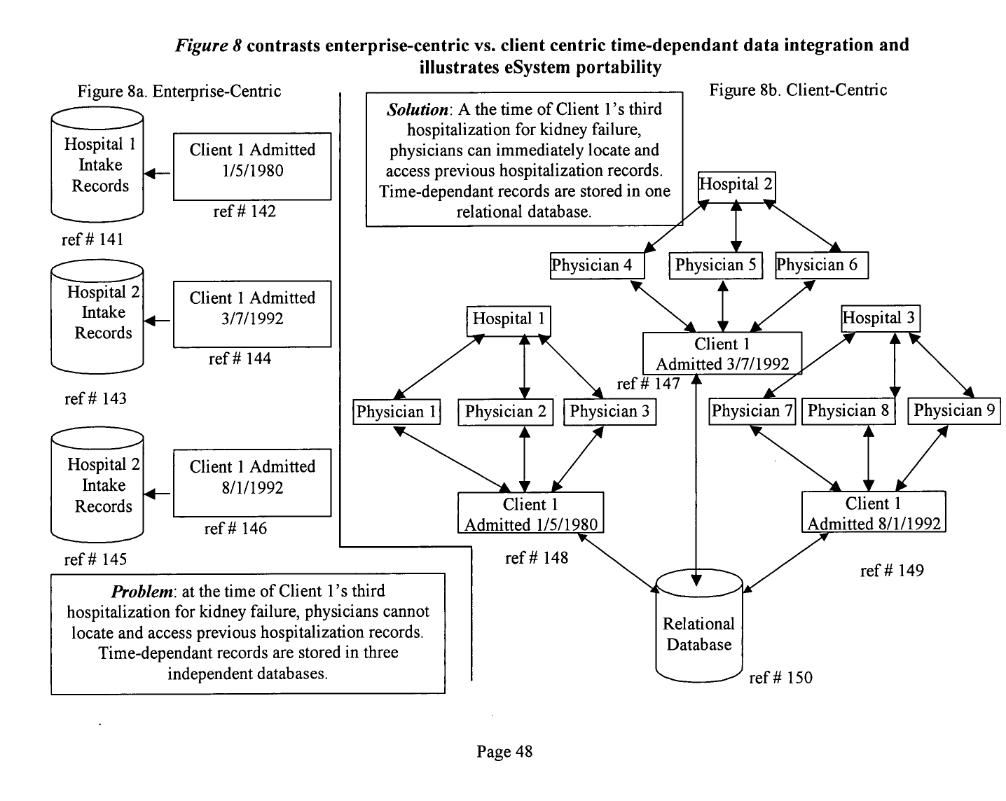

FIG. 8 shows the invention's portability and contrasts enterprise-centric vs. client-centric time-dependent data integration. In this example, Client 1 has been admitted at three different times to three different hospitals for kidney failure.

FIG. 8a shows conventional enterprise-centric time-dependent data integration. FIG. 8a shows three independent enterprise-centric databases (ref# 141, 143, 145) each operated by a hospital in California, Michigan, or Florida. In each database are records from admissions of Client 1 during kidney failure (ref #142, 144, 146) at a different time. Client 1 is unconscious when he is admitted for his third hospitalization (ref# 142). Physicians at Hospital 3 who examine and treat Client 1 have no way to locate or access previous time-dependent hospitalization records (ref# 142, 144) that are of critical importance to Client 1's recovery.

FIG. 8b illustrates the invention's unique client-centric time-dependent data integration feature, an expression of the invention's unique system and methods. FIG. 8b shows one relational database (ref# 150) integrating time-dependent records from three hospitals in California, Michigan, and Florida related to admission of Client 1 during kidney failure (ref #148, 147, 149). Client 1 is unconscious when he is admitted for his third hospitalization (ref# 149). Physicians 7, 8, and 9 who examine and treat Client 1 during his third admission (ref# 149) can immediately locate and access previous time-dependent hospitalization records (ref# 147, 148) that are of critical importance to Client 1's recovery.

FIG. 8b also illustrates the invention's portability feature, an expression of the invention's unique system and methods. As a consumer changes doctor's and hospitals, he can remove authorization from some account users and establish authorization for other account users. All this is accomplished without any loss of information in the client account.

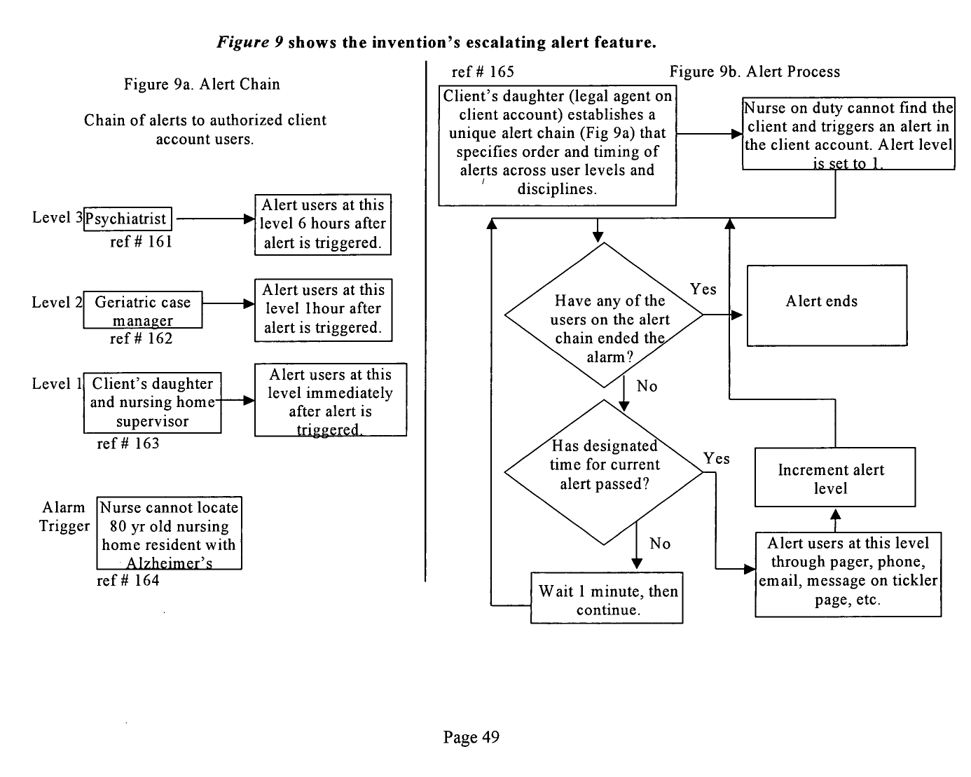

FIG. 9 shows the invention's escalating alert feature. In this example, the client is an 80-year-old Alzheimer's patient and nursing home resident.

FIG. 9 illustrates the invention's unique escalating alert feature, an expression of the invention's unique system and methods. The escalating alert feature is possible only in a client-centric system that integrates users across levels and disciplines as depicted in FIG. 5.

This example shows how the alert chain works. As FIG. 9 shows, the alert chain (FIG. 9a) is triggered (ref# 164) when a nurse cannot locate an 80-year-old Alzheimer's resident of a nursing home. The client's daughter (legal agent on client account, ref #165) establishes a unique alert chain for her father's client account that is deployed via standard alert process shown in FIG. 9b. The alert chain in FIG. 9a specifies the unique order and timing of alerts issued via a standard alert process (FIG. 9b) across user levels (e.g., client's daughter, geriatric case manager, nursing-home supervisor) and disciplines (e.g., psychiatry, geriatric case management) (ref# 161-164). The escalating alert feature is possible only in a client-centric system that integrates users across levels and disciplines as depicted in FIG. 5.

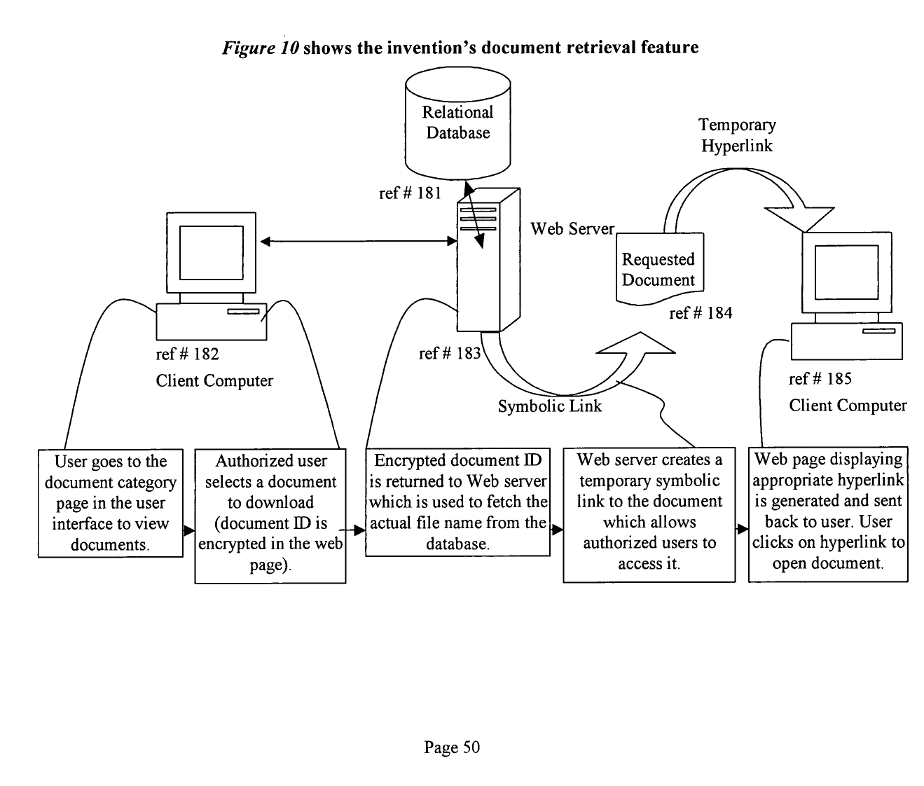

FIG. 10 shows the invention's document retrieval feature. FIG. 10 illustrates the invention's unique document retrieval feature, an expression of the invention's unique system and methods. The document retrieval feature is possible only in a client-centric system that establishes unique authorization privilege records to each data category in a client account for each account user as depicted in FIG. 1 and that protects consumer privacy as depicted in FIG. 6.

This example illustrates how the document retrieval feature works. An authorized account user in Boston (the client) stores his original documents (e.g., x-rays, living wills, and psychiatric evaluations) in relevant data categories within his client account (e.g., medical, legal, mental health). Later, another user in Detroit (the client's lawyer) uses his computer (ref# 182) to access the relevant document category page in the user interface and select a document (e.g., living will) to download. The encrypted document ID for the selected document is returned to the invention's Web server (ref# 183), which is used to fetch the actual file name from the relational database (ref# 181). The Web server (ref# 183) creates a temporary symbolic link to the requested document (ref# 184). The Web page displaying the appropriate hyperlink is generated and sent back to the user so that the client's lawyer in Detroit can access the requested document via his computer (ref# 185).

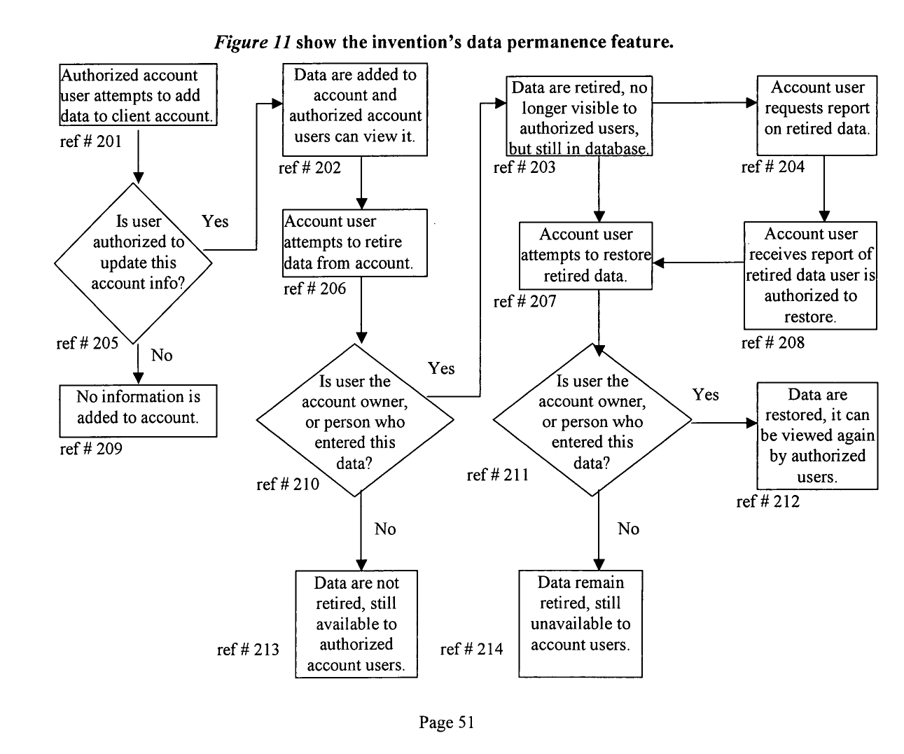

FIG. 11 Shows the Invention's Data Permanence Feature.

FIG. 11 illustrates the invention's unique data permanence feature, an expression of the invention's unique system and methods. The data permanence feature is essential for operation of a client-centric system that integrates information relevant to one client across data categories (FIG. 7), across users (FIG. 5), and across time (FIG. 8). With data permanence, the client account becomes an unquestionably objective and reliable repository of information about the sequence of activities of one or more authorized users and a solid foundation for the audit trail feature described in Example 1. Without data permanence, a nurse involved in a fatal medical mistake could delete pertinent information.

This is how the data permanence feature works. The eSystem's relational database includes business rules, shown in FIG. 11, to determine changes that can be made in client account information. The eSystem's programming logic checks the user's authorization record and presents a client account user interface consistent with user access privileges. In brief, here are the business rules related to data permanence. A user must be authorized to add information in a specified data category (ref# 205). Only the client account legal agent or person who entered data may retire data from the account to an archive (data are never deleted, can always be restored from archive, some data can never be retired) (ref# 213). Only the client account legal agent or person who entered data can restore the data to view (ref# 211). Whenever data is retired or restored, the client account legal agent is notified via a system message. Thus, no user can retire or restore data without the knowledge of the legal agent.

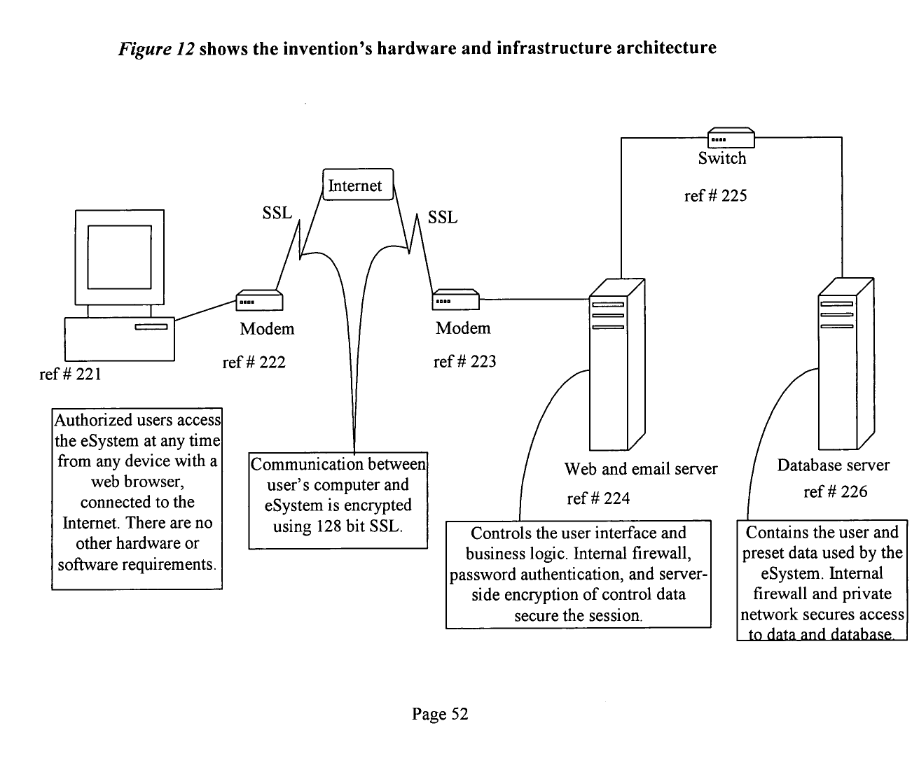

FIG. 12 shows the invention's hardware and infrastructure architecture comprising the user's Internet browser, modem equipped device (ref# 221), programming that encrypts communication between the user's device and the eSystem (ref# 222, 223), a Web and email server that controls the user interface and business logic (ref# 224), a switch (ref# 225) that connects to the database server (ref# 226). The switch is a standard piece of network hardware that facilitates communication between application and database servers.

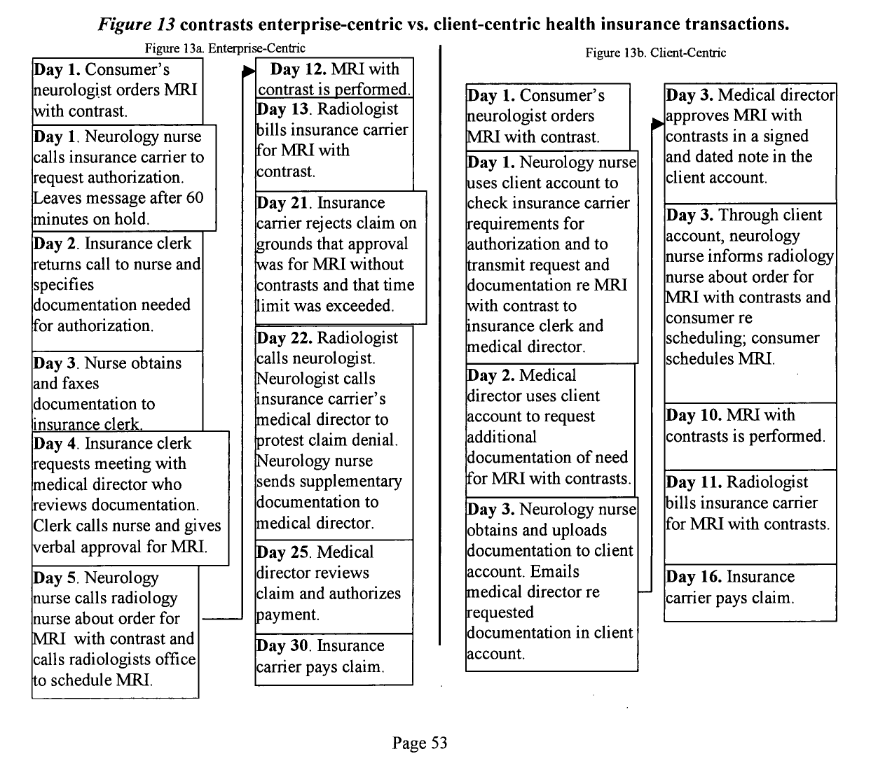

FIG. 13 Contrasts Enterprise-Centric vs. Client-Centric Health Insurance Transactions.

FIG. 13a illustrates conventional enterprise-centric health insurance transaction. With or without the support of an enterprise-centric medical records system, enterprise-centric health insurance transactions take longer, cost more money, and are fraught with more errors than the client-centric method. Most of the people involved in health insurance transactions, including clients and family caregivers, have no access to the enterprise-centric record system. The information needed for cost-effective health-insurance transactions is fragmented across record-keeping systems specific to data categories (FIG. 7), user levels and disciplines (FIG. 5), and time (FIG. 8).

FIG. 13b illustrates the invention's unique client-centric health insurance transaction feature, an expression of the invention's unique system and methods. Cost-effective health insurance transactions are possible only in a client-centric system that integrates all of a client's healthcare information in one relational database across data categories (FIG. 7), users (FIG. 5), and time.

This is how the client-centric health insurance transaction works as illustrated in FIG. 13. A claims clerk at the health insurance carrier and the medical director are established as authorized users on the health insurance category of a customer's client account (and on no other data category). Following an electronic handshake between the client and the insurance carrier, the health insurance category of the client account receives an additional page branded with the company name “Safety Net Inc.” From this page, all authorized client account users can access the client's policy, the company's requirements for procedure certification, and Web page claims forms. Client and healthcare providers can fill in these Web page forms while in the client account, and submit them directly to the insurance company's payment agents and medical directors through their superuser account. Copies of the submission remain in the client account. All relevant parties are notified on their message boards about the submission. All transactions are tagged with the user ID. Given this permanent electronic identification, in documents and in audit trails, there is no need to download, sign, notarize, and upload documents for transmission. Documents involved in transactions are sent in permanent, read only, form. The insurance company rep can transmit information about claims into the account with automatic notification of all relevant account users and others with need to know who are not account users. Through the client account, the insurance carrier's medical director can request and receive documentation from account users such as the doctor's progress notes, requests for procedures, and accompanying documentation and test results. Through the client account, the insurance carrier can definitively inform account users about parameters of certification of requested procedures.

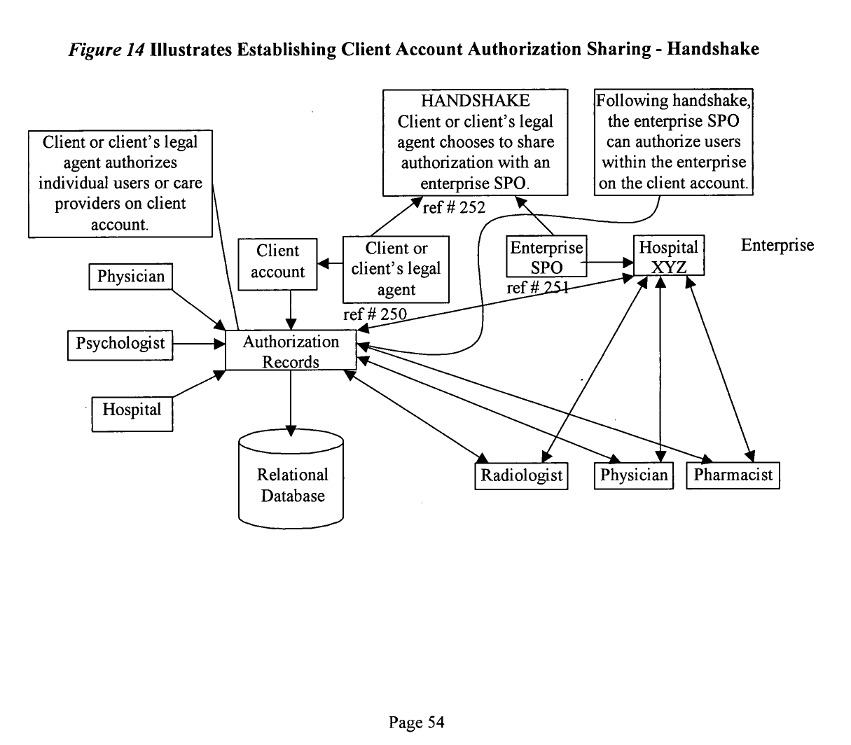

FIG. 14 Shows how the Invention Allows Authorization Sharing Over a Client Account Through a Handshake Agreement Between a Client Account Legal Agent and an Enterprise SPO.

The client account legal agent (ref# 250) always retains ultimate authorization power over a client account. But, if they choose, they may grant limited authorization power to an enterprise Security and Privacy Officer (SPO) (ref# 251). This power is granted through a handshake agreement (ref# 252) between these users. While the agreement is in place, the enterprise SPO can authorize users, from within their enterprise, on the client account.

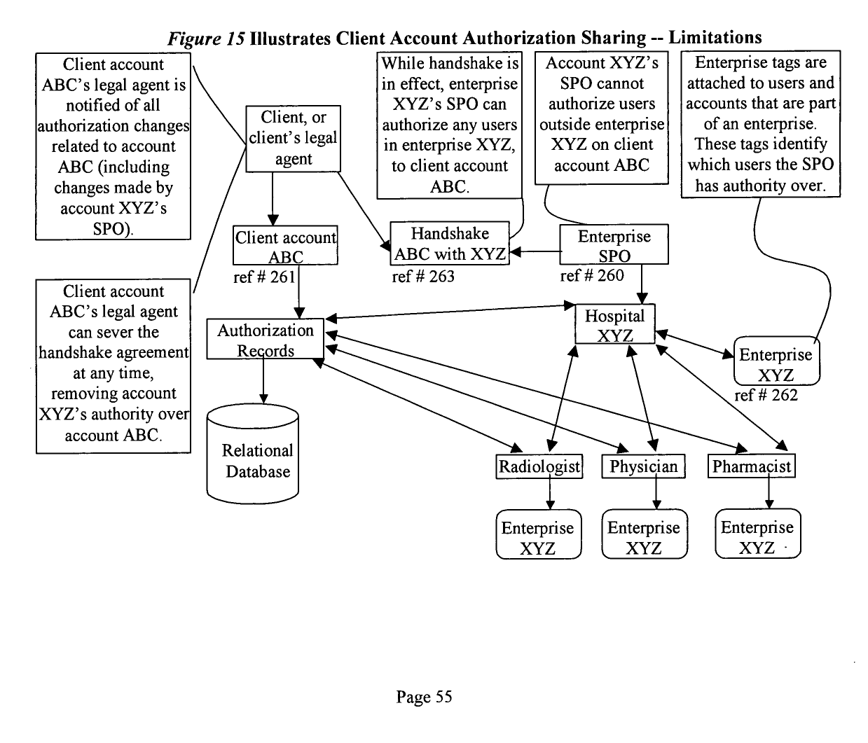

FIG. 15 Shows how the Invention Limits Authorization Sharing Over a Client Account Through a Handshake Agreement Between a Client Account Legal Agent and an Enterprise SPO.

When an enterprise SPO (ref# 260) is granted authorization power over a client acount (ref# 261), this power is limited to the users and accounts that are designated as part of their enterprise. The system maintains tags (ref# 262) on these users and accounts so that it can recognize which users and accounts an enterprise SPO is allowed to act on. An enterprise SPO is unable to authorize a user outside their enterprise, on a client account.

While the handshake agreement (ref# 263) is in effect, both the client account legal agent and the enterprise SPO, share authorization power over authorizations between the enterprise and the client account. Either of these individuals can add, change or delete authorization records between these entities. The system notifies the client account legal agent of all authorization changes affecting the client account (including those made by an enterprise SPO). The client account legal agent always retains the ability to cancel a handshake agreement with an enterprise SPO.

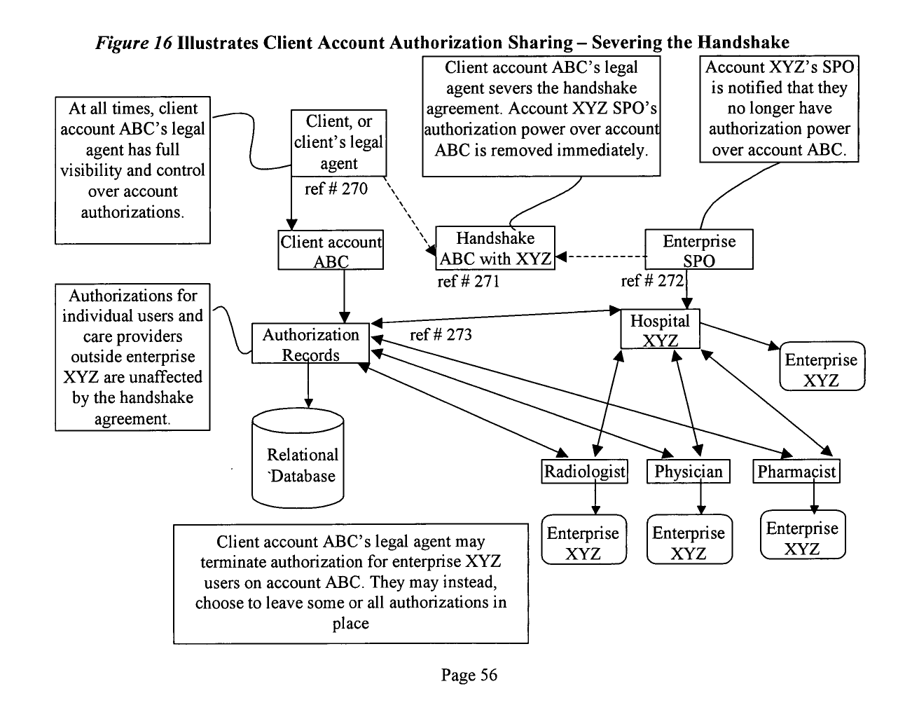

FIG. 16 Shows how the Invention Allows a Client Account Legal Agent to Sever a Handshake Agreement, Removing an Enterprise SPO's Authorization Power Over the Client Account.

For any reason, the client account legal agent (ref# 270) may sever a handshake agreement (ref# 271) with an enterprise SPO (ref# 272). The legal agent severs the handshake agreement through the client account user interface. The interface provides a view of all handshake agreements that are in place, and has options for the legal agent to end these agreements. When this occurs, the enterprise SPO's authorization power over the client account is immediately removed. The SPO is notified of this change in authorization power.

After severing the handshake, the client account legal agent retains authorization power over the authorizations (ref# 273) established by the enterprise SPO. They can make any changes to those authorizations that they wish, including terminating any or all of them.

### EXAMPLE 1 SHOWS THE INVENTION'S CLIENT-CENTRIC AUDIT TRAILS FEATURE

Example 1 illustrates the invention's unique audit trails feature, an expression of the invention's unique system and methods. Enterprise-centric systems have audit trails, but they document only the activities of enterprise users, not the activities of consumers and family caregivers as well as other account users involved in client care but not associated with the enterprise. As such, enterprise-centric systems do little to protect healthcare providers against malpractice claims. The client-centric audit trail documents in chronological sequences the activities of clients, family caregivers, and all the authorized provider and enterprise account users who are involved in consumer care.

The client-centric audit trail is made possible by an eSystem that integrates users (FIG. 5), integrates data categories (FIG. 7), integrates time-dependent data (FIG. 8), and protects data permanence (FIG. 11).

This is how the client-centric audit trail feature works. An audit trail automatically documents each step an authorized user makes in one client account or across client accounts through a superuser account. Audited information includes user ID, dates and times of account access, dates and times of access to data categories in the account; dates and times of access to functions and documents within data categories. All audited information is permanent and cannot be deleted, edited, or retired for archiving by any account user including the named client or legal agent. In fact, only a representation of audited information is available through reports generated via client or superset accounts. An audit trail report shows only data category information consistent with a user's access privileges on an account. Users generate audit trail reports by clicking a “Reports” button on the left navigation bar of the Client or Superuser Account Home Page, and then an “Audit Trail” button. A generic reports specification page opens, requesting search parameters including date range, account users, and data categories. The requested audit trail report appears on the user's screen. Even after a user's access to a client account is terminated, the user can generate an audit trail for the period of authorization consistent with then prevailing access privileges.

Example 1 illustrates how the client-centric audit trail feature works. In the case summary (left column, top paragraph), a primary care doctor may be liable for a patient's adverse reactions to medication the doctor prescribed. The doctor asked the right questions prior to prescribing, but got misleading information from the patient's daughter, that she later denied when initiating a malpractice claim. Example 1, left column, bottom paragraph describes how a doctor can use the client account to prevent liability. Example 1, right column, top paragraph describes how a doctor can use the audit trail to prove a reasonable standard of care and minimize liability. A snapshot of a relevant audit trail report is presented in Example 1, right column, bottom paragraphs.

### EXAMPLE 1

### EXAMPLE 1 SHOWS THE INVENTION'S CLIENT-CENTRIC AUDIT TRAIL FEATURE

Case Summary. A 75-year-old male, Bob Jenkins, presents to a primary care doctor, Sam Siegel, complaining of intolerable back pain and exhibiting some disorientation. Pt does not know today's date and says, “I'm taking the fifth” when asked to identify the president of the United States. Pt. has just moved to Colorado from Minnesota to live with daughter Susan Jenkins who accompanied him to the doctor's office. Pt's daughter begs doctor to give her father some painkillers, stating that she will “leave him on a park bench,” otherwise. Nurse asks daughter and Pt about Pt's prior allergic reactions to meds. Neither mentions any. Doctor prescribes codeine, discusses possible contraindications (including prior adverse reaction) with Pt and daughter, and recommends that daughter consult a local geriatrician re possible diagnosis of Stage 1 Alzheimer's. Two days later, the daughter's attorney calls indicating that Pt has had adverse reaction to codeine and has been admitted to local community hospital via the emergency room. Daughter (per attorney) claims that she told the doctor about her father's prior allergic reaction to codeine and stated, “he almost died from it.”

Using the client account to prevent liability. The primary care doctor's nurse assigns a client account to each new and existing patient. Either the named patient or the patient's designated family caregiver is assisted in setting up the account, providing information about vital healthcare information including current medications, allergies, and past and present medical conditions including allergic reactions. This vital healthcare information appears on the client home page when any user enters the account. The patient or family caregiver (legal agent on client account) authorizes the primary care doc as a user with full privileges in the medical data category. Prior to an office visit (either from a home computer or from a PC in the doctor's office, patient and/or family caregiver are required to: (1) review the client account home page and check a box indicating that all vital information is current, and (2) state the complaint(s) they want the doctor to address and the remedies they prefer. Before the doctor enters the exam room, he accesses the client account with own unique Logon ID and password (insuring that he leaves a footprint in the audit trail) and reads through the current statement of vital information and reason for office visit (leaving a trace in the audit trail of this action). In the exam room, once the doctor is ready to write a prescription for the patient, he accesses the client account via a pocket PDA. From inside the client account, he writes a prescription and sends it to the client's selected pharmacy for fulfillment. The patient or family caregiver receives a copy of the doctor's order on the message board in the user home page. The complete doctor's order may be sent later following transcription of doctor's dictation expanding upon aspects of the SOAP note that require patient and family caregiver understanding. When client or designated family caregiver open the message from the doctor, the audit trails registers this action. In most cases, usage of the client account in this fashion will prevent the kinds of situations that lead to malpractice claims.

Using the audit trail to minimize liability. In the case summarized above, the same sequence of events might have occurred. Daughter and father could have reported no prior adverse reactions from codeine. However, the doctor (or his nurse) could easily generate an incontrovertible audit trail report via the doctor's superset account. He could do this even if the patient's daughter revoked his authorization privileges on the client account following the office visit. What follows are excerpts from a relevant audit trail report.

Audit Trail Search for:
User id: 2345 (Primary care doc)
User id: 23451 (Nurse)
Client account id: 4592 (Bob Jenkins, Pt).
User id: 45921 (Susan Jenkins, legal agent)
Start date for search: Mar. 22, 2003
Data category: Medical
Show: All transactions and linked documents

Audit Trail Report:

March 22, 10 to 10:15 a.m. User id: 45921, User enters “none” in “current allergies” field. User enters “none” in “any bad reactions to medications in past” field. User enters “back pain” in “describe reason for patient's visit today” field. User enters “prescribe painkiller” in “what would you like the doctor to do for patient during this visit?” field. User enters “I don't know what to do with my father, he's driving me crazy” in the “Any other problems you'd like to talk to the doctor about today” field.

March 22, 10:20 a.m. User id: 2345. User opens “vital information” and “today's visit” in client account id 4592.

March 22, 10:40 a.m. User id: 2345. User exercises Rx privileges via superset account id 72459. Copy of prescription for “codeine” sent to “Star Pharmacy” for “customer pickup.” Message with dosage, use instructions, and contraindications (such as prior adverse reactions to class of drugs) sent to “Star Pharmacy” for “customer acknowledgment signature” and to user id 45921 message board on user home page.

March 22, 3 p.m. User id: 45921. User accesses client account id 4592. User views message from “Dr. Sam Siegel” re “Rx for Bob Jenkins.” User clicks “yes” to “I have read and understand this information.”

### EXAMPLE 2 SHOWS THE INVENTION'S COORDINATED ASSESSMENT AND REFERRAL FEATURE

Example 2 illustrates the invention's unique coordinated assessment and referral feature, an expression of the invention's unique system and methods. Rapid, safe, and cost-effective assessment and referral of consumers requiring complex community care is possible only in a client-centric system that integrates all of a client's community care information in one relational database across data categories (FIG. 7), users (FIG. 5), and time.

### EXAMPLE 2

### EXAMPLE 2 SHOWS THE INVENTION'S COORDINATED ASSESSMENT AND REFERRAL FEATURE

The context for this figure is a county coalition of agencies (superset account) providing a community based system of care for juvenile offenders (client accounts). The example illustrates how the county uses the eSystem for coordinated assessment of juveniles following an arrest, and for referral to a team of educational, health and human services, and justice system providers and enterprises (superset account users).

Saturday night: 15 year old Max is arrested for drunk driving, his first offence. Max is detained in the county jail.

Monday, 10 am: Max appears before the juvenile court magistrate with his father, Tom. Given the need for assessment of Max prior to adjudication, the judge releases Max to Tom's supervision and assigns a client account to Max.

Monday, 1 pm: Sally, a juvenile probation officer assists Max and Tom in establishing the account and designating Tom as the legal agent, and Sally as an authorized user. They also designate the judge, a school psychologist, a county social worker, and Max's grandmother, Ruth, as account users.

Monday, 2 pm: On two public access computers at the justice center, Max and Tom each enter the client account, and independently respond to a series of standardized assessment measures related to Max's substance abuse, behavior problems, delinquency, and depression.

Monday 2-5 pm: School psychologist and the county social worker enter information and files into Max's client account related to school achievement, learning problems, and prior school behavior problems. Max is a special education student and so is IEP and progress reports are added to the account. Tom also adds Max's special-education teacher as an authorized user on the client account.

Monday pm: Max spends the evening, as Sally requested, with his father on a public library computer accessing Max's account. They begin to block out a 24/7 supervised schedule for Max that includes school attendance, chores, homework, basketball practice, dinner each evening with Tom and free hours with Grandma Ruth.

Tuesday, 8 am: In a meeting with Ruth, Max and Tom go over the results of the standardized assessment report generated automatically within the client account. In a conference call with the school psychologist and social worker (with everyone in the client account, viewing the assessment report together), decisions are made about services Max needs: intensive supervision, after school tutoring, and community service. Before the call is over, Sally summarizes the team's conclusion and sends a message to the judge's superuser account requesting approval of the plan. The judge can then open this message, view results of the assessment, and approve the plan.

Tuesday, 9 am: Via her superuser account, Sally consults a coordinated court schedule for activities available to court-referred youth. She schedules referrals for Max directly into his client account schedule, and into the schedules of referral providers who have been added as users to Max's account. They will have immediate access to the standardized assessment report. All account users receive reminders on their schedules of activities. Max's schedule, which they supervise, monitor or provide. All confirm when Max shows up as scheduled. Sally is alerted if Max or a provider fails to adhere to the schedule.

### EXAMPLE 3 SHOWS THE INVENTION'S COORDINATED CASE MANAGEMENT FEATURE

Example 3 illustrates the invention's unique coordinated case management feature, an expression of the invention's unique system and methods. Cost-effective case management consistent with empirically validated standards of community care is possible only in a client-centric system that integrates all of a client's community care information in one relational database across data categories (FIG. 7), users (FIG. 5), and time.

### EXAMPLE 3

### EXAMPLE 3 SHOWS THE INVENTION'S COORDINATED CASE MANAGEMENT FEATURE

The context for this example is a county coalition of agencies (superset account) providing a community-based system of care for juvenile offenders (client accounts). The example illustrates how the county uses the eSystem for coordinated case management of juvenile offenders. This follows example 2, illustrating assessment and referral.

The court's terms and conditions for Max are designated in a treatment plan in Max's client account. Max's treatment team includes Max, his father Tom, his grandmother Ruth, his probation officer Sally, a school psychologist, a county social worker and Max's special education teacher. The conditions of Max's IEP are incorporated into the overall treatment plan.

The treatment plan is converted into activities in Max's schedule with a member of the team assigned to monitor, supervise or provide each activity. Both Max and the assigned supervisor must confirm through the client account when Max shows up as scheduled for an activity. The treatment team engages Tom and Grandma Ruth in constructing a 24/7 supervision schedule for Max that will persist for the next year, as per the judge's orders, and court's terms and conditions for Max.

Each member of the treatment team, authorized users on Max's account, receive daily reminders on the tickler in the user home page about responsibilities for Max's supervision. Beside the tickler, the user clicks a checkbox to confirm Max's attendance at scheduled activities.

A chain of automatic escalating alerts notifies team members and other account users if Max does not show up for scheduled activities, goes AWOL or evidences behavior potentially harmful to himself or others. The team has already designated some emergency treatment options that can be deployed by a button press through Max's client account.

The team members who have professional responsibilities to submit progress notes or case reports to supervisors or to the court, can automatically generate reports at any time via Max's client account.

Max is required to submit to random drug tests and breathalyzers. A technician at a drug testing facility schedules an alarm that goes off in Max's client account, notifying Max to show in 4 hours at the facility. The drug test results are stored as documents in Max's client account. Account users are automatically notified about positive drug test results.

Max and Tom are periodically required to respond again to assessment measures (first administered at intake) through the client account. The tests are scored and a test report is automatically generated and made available to treatment team members through their superuser accounts.

Consistent with Max's history of schedule adherence, school progress, drug assessment results, the treatment team tweaks Max's treatment plan and his schedule.

Through her superuser account, Sally automatically aggregates data across juvenile offender clients and produces statistical reports for the state department of correction and for the court.

1. A client-centric Internet information method for accessing a client centric relational database via a given website on the Internet with the relational database containing client account database records stored in a multiple of different data categories each representative of a different type of information and records of multiple different functions corresponding to different data operations, comprising the steps of:
forming a client user interface for each named client in the database including the designated legal agent of the client and for each authorized user separately identified by the client to access the relational database via the client user interface;
assigning a client account ID number for each client account in the database and a password for providing access to a client account by the client and legal agent thereof and assigning a User ID number and password for each authorized user identified by the client to access the relational database via the client user interface;
storing authorization records in the relational database defining the categories and functions of operation for each client account;
encoding the authorization records for each client account in the relational database with client specified privileges defining the data categories that can be entered and functions of data operations to be permitted each authorized user, with the client and legal agent thereof having access to revise the privileges in the authorization records including termination of such privileges for any authorized user;
opening a client account in the relational database via selection of the Internet website upon entry of an authorized User ID number and password;
searching the authorization records upon the opening of a client account to determine the authorized user's access privileges in such account and
limiting the activity of the authorized user to only the categories and functions of data operations defined by the privileges in the authorization records.

2. A method as defined in claim 1 permitting the client and authorized user's to only archive but not delete information in the client account and notifying the client and/or legal agent thereof whenever any authorized user achieves information in the client account.

3. A method as defined in claim 1 wherein each authorized user is assigned an account for display of a user home page on a video monitor such that upon entry of the User ID and password the client user interface identifies the user's account and from the authorization records displays the access privileges to data categories and the functions of client approved data operations within the client account.

4. A method as defined in claim 3 wherein the client user interface permits each authorized user to perform the functions of client approved data operations within the client account selected from the group consisting of viewing, data searching, updating, editing, retiring, aggregating and restring information.

5. A method as defined in claim 4 wherein the client user interface permits category integration between a plurality of authorized users to the same named client account for enabling the plurality of authorized users to share information concerning the named client and to coordinate service.

6. A method as defined in claim 5 linking authorized users with existing privileges to more than one client account corresponding to a superset account to simultaneously have access to each authorized account in the relational database by linking the User ID for each different client account given to the same authorized user such that one user ID logon and password by the same authorized user will provide access to all common authorized client accounts with the user home page displaying the different access privileges to each account separately and for permitting data operations on all or the selected subsets of client accounts.

7. A method as defined in claim 5 wherein each action of a user in a client account is automatically registered and audited with information selected from the group consisting of one or more data entries including; time, date, data category and data operation within the data category for generating an audit trail report for examining performance of client account users.

8. A client-centric Internet information system for accessing a client centric relational database via a given website on the Internet with the relational database containing client account database records stored in a multiple of different data categories each representative of a different type of information and records of multiple different functions corresponding to different data operations, wherein the relational database contains a client account ID number for each client account in the database and a password for providing access to a client account by the client and legal agent thereof and a User ID number and password for each client specified authorized user comprising:
a client user interface which permits each named client in the database including the designated legal agent thereof and each authorized user to access the relational database;
computer means including a browser for communicating via the Internet through said website and client user interface to the relational database;
authorization records stored in the relational data base that defines the categories and functions of data operation for each client account and client specified user privileges limiting the data categories that can be entered and functions of data operations which each authorized user can perform in an authorized client account;
means in the client user interface for recognizing user access privileges in the authorization records upon use of the computer means to enter the system with a User ID number and password with the client user interface limiting access to such authorized user to privileged activities in the categories and functions of data operations defined in the authorization records for such authorized user, and
wherein the client and/or legal agent thereof can through computer means can access the authorization records stored in the relational data base to revise the privileges in the authorization records including termination of such privileges for any authorized user.

9. A client-centric Internet information system as defined in claim 8 further comprising software means for controlling said client user interface for defining and limiting the access privileges for each authorized user to specific data categories and data functions within data categories as designated by the client for each authorized user.

10. A client-centric Internet information system as defined in claim 9 wherein said user interface under the control of said software means permits category integration between a plurality of authorized users to the same named client account consistent with the access privileges of each authorized user for enabling the plurality of authorized users to share information concerning the named client and to coordinate service.
